(19) United States
(12) Patent Application Publication
(10) Pub. No.: US 2004/0079447 A1
(43) Pub. Date: Apr. 29, 2004

(54) Oxygen cutting of slabs

(76) Inventors: Valerie Donze, Laxou (FR); Bertrand Donze, Dugny (FR); Pascal Donze, Nancy (FR); Thierry Rozot, Thorey Lyautey (FR); Ken Wright, Dearborn, MI (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/281,730

(22) Filed: Oct. 28, 2002

(51) Int. Cl. B23K 7/00

(52) U.S. Cl. 148/194; 266/65

(57) ABSTRACT

The invention concerns a flame-cutting process for a parallelepiped slab using one or more flame-cutting blowtorches and a device for its implementation. In accordance with the invention, a slab, lying flat, is lifted using a lifting device to bring its primary plane into a vertical position, and hold it in a vertical position. A relative vertical movement is made between the flame-cutting blowtorches and the slab to cut the slab as it passes before the activated flame-cutting blowtorch.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The invention involves a flame-cutting process for a parallelepiped slab using one or more flame-cutting blowtorches, and a device for its implementation.

Some of these processes are known from the trade, such as the one described in the French patent application, publication number 2 746 686. In this process, the slab is placed on its edge in a series of rollers linked together to allow the slab to pass before a flame-cutting blowtorch between pairs of loosely-mounted vertical rollers.

In the European patent application number 00202767.0 dated Aug. 4, 2002 (which corresponds to U.S. Ser. No. 09/921,969, now Pat. No. ______, and which is incorporated herein by reference), a flame-cutting process for slabs and a device for its implementation are described. The slabs are cut to size or loaded in a horizontal position or on their sides, and suspended by electromagnets below the guiding rollers.

These processes and systems are not suitable for processing of standing slabs, whose length can reach 14 meters.

### BRIEF SUMMARY OF THE INVENTION

The goal of the invention is to provide a flame-cutting process for standing slabs, and a device for its implementation.

This goal is achieved, according to the invention, using a slab flame-cutting process, according to which a slab lying flat is lifted using a lifting device to bring it to its primary plane in a vertical position. The slab is held in this vertical position using the lifting device, and a relative movement in the vertical direction is made between one or more flame-cutting blowtorches and the slab, to cut the slab as it passes before the previously-activated flame-cutting blowtorch.

According to the invention, the device for implementation of the flame-cutting process includes at least one flame-cutting blowtorch, a lifting device to lift the slab from a prone position and placing it in front of the blowtorch with its primary plane in a vertical position and keeping the slab in this position during the cutting operation, and a means for moving the blowtorch in a vertical direction up or down the length of the primary plane of the slab in the vertical position.

In a preferred method of production of the invention, the lifting device comprises one or more electromagnets which, in order to lift the slab, are placed in contact with the side of the slab that is furthest from, and opposite to, the flame-cutting blowtorch. The electromagnet is subjected to a combined vertical and transverse movement, which is perpendicular to the plane of the vertical position, in order to bring the primary plane of the slab into the vertical position.

The device for implementing this preferred production method of the invention assumes that the lifting device is an electromagnet, which is mobile in the vertical and transverse directions relative to the primary plane.

Moreover, the system can include a device intended to receive the lower edge of the slab, when the slab is standing in the vertical position or on its side.

According to a second preferred method of production of the invention, the lifting device acts from below the slab edge in order to tip the slab around the edge that is nearest to the blowtorch(es), with its primary plane against a vertical plane, and hold it in place in this vertical position.

In the device for implementation of this second preferred method of production of the invention the lifting device includes a slab-support table which can tip between a horizontal resting position and a working position that is perpendicular relative to the resting position, and at least one straight support post that is vertical to the horizontal rest or holding position. The lifted slab, when its primary plane is in the vertical position, is caught between the table in the work position and the support post.

Moreover, the device according to the invention can include at least one hydraulic actuator, joined at one end to a base, and at the other end to one end of the table in order to tip the table to its horizontal position around the opposite end of the table in its vertical work position.

Other methods of construction are described and claimed in the relevant claims.

### BRIEF DESCRIPTION OF THE SEVERAL VIEWS OF THE DRAWINGS

The invention will now be described as an example, with reference to the preferred methods of construction of the invention represented in the attached drawings, in which:

FIG. 1 is a schematic representation of a method of production of the invention, and

FIGS. 2a and 2b are top plane and side elevational representations, respectively, of a second method of production of the invention.

Corresponding reference numerals will be used throughout the several figures of the drawings.

### DETAILED DESCRIPTION OF THE INVENTION

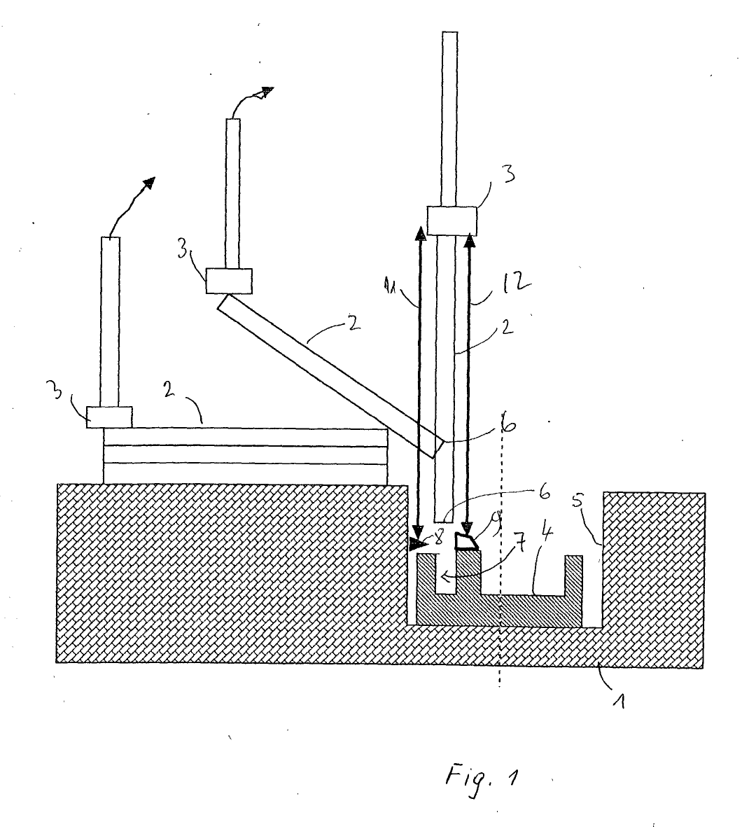

FIG. 1 shows a schematic view of a preferred method of production of the slab flame-cutting device according to the invention. On a foundation 1, at left, is a pile of slabs 2 to be cut to size or to be trimmed. For it to be cut, a slab 2 is placed in a vertical standing position; to be trimmed it is placed on its side. The slab 2 is lifted using one or more suspended electromagnets 3, e.g. using a sling with a frame or half-frame or other appropriate lifting device. In this way, the electromagnet is movable vertically relative to the slab 2 and movable horizontally in the transverse direction to slab 2, both to the left and the right. At the bottom of a pit 5 is a vise clamp 4, designed to hold the lower edge 6 of slab 2 to be cut up.

In order to cut slab 2, the slab is held using an electromagnet 3 furnished on the edge of the slab that is opposite pit 5; the electromagnet is lifted and slab 2 rises. The electromagnet 3 is shifted laterally to the right. As the electromagnet 3 is lifted and moved to the right, the slab 2 tips around the opposite edge until finally its primary plane is vertical relative to the vise clamp 4. Once it is above the tong hold 7 of the vertical hold (e.g. of a vise moved by an actuator, the slab 2 may be lowered. But before the flame-cutter burner 8 and trimmer 9, found on the upper part of the vise, are activated, both sides of the tong hold are activated. The slab 2 is lowered into the tong hold 7 until the lower edge 6 touches the bottom of tong hold 7. Cutting of slab 2 begins when the lower edge passes before flame-cutter 8 as the slab is lowered into the tong hold 7 and continues by moving the flame-cutter 8 and trimmer 9 together upwards, as indicated by double arrows 11 and 12, respectively. Once the flame cutter and trimmer get to the top of slab 2, the slab has been completely cut into two or more slabs of lesser width depending on the number of cutters/trimmers 8/9 that were used.

The cutter/trimmer 8/9 is lowered into pit 4 and the trimmed slabs are pulled back into the vise clamp to make way for a new slab 2 to be cut.

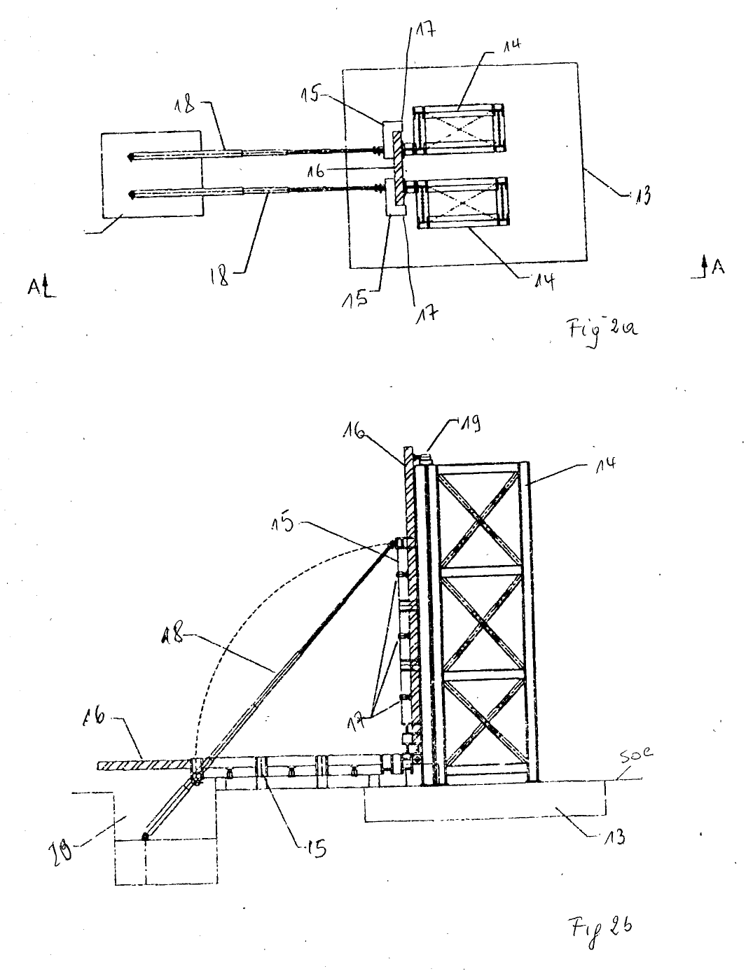

A second method of production of the invention is shown in FIGS. 2a and 2b as a horizontal projection and seen from the front. This method of production includes a foundation 13 with at least one slab support post 14, and preferably at least two support posts 14, depending on the width of the slabs to be cut. It is also possible to provide more than two posts. The total height of the posts 14 is a function of the length of the slabs, which can reach 14 meters.

Slab support post 14 features, on its left side in FIG. 2a, a flat side, perpendicular to the horizontal, which will serve as a support to the slab to be cut in a standing position.

On the left of the post in FIG. 2 is a slab-support table 15 with appropriate horizontal extensions for this purpose, which is represented in FIG. 2b in a vertical working position and in a horizontal rest position. The table 15 can be tipped around its edge near the post 14 to tip horizontal slab 16 into a vertical position against post 14 to be re-cut. A joint appropriate for this use is provided. The slab-support table 15 can be fitted, at each of its lateral longitudinal sides, with a lip 17 which extends back to prevent the slab 16 from falling off the slab-support table 15 while it is being transferred from its horizontal rest position to its vertical work position.

Means of pressure control 18 are provided longitudinally and laterally in the body of the slab-support table 15 in order to exert appropriate pressure uniformly on all surfaces of slab 16 in the vertical standing position, and to press the slab 16 uniformly against the flat vertical surface to the left of slab support post 14. The pressure control means includes horizontal thrust arms 19 at the upper end on post 14 to act horizontally and to vertically adjust the upper end of slab 16, passing slab-support table 15.

At least one, and preferably two, hydraulic actuators 18 are provided to tip the slab-support table (15) into its vertical work position. The actuator is joined by one of its ends to a base and the other end to the left edge of slab-support table 15. Through the action of the hydraulic actuator 18, the actuator extends or contracts and the slab-support table 15 is tipped from its horizontal rest position to its vertical work position and vice-versa. The end of actuator 18 joined to the base may be lowered into a pit 20.

A flame-cutting burner (not shown) and a trimming system (not shown) on the opposite side are mounted such that when slab 16 is trimmed, they are located on either side of the primary plane of the slab 16, and thus in the tong hold 7, and can be moved vertically from top to bottom and vice versa, e.g. between the two posts 14, or to the side of post 14 when there is only one post. When there are two posts 14, the slab-support table 15 is provided with a free longitudinal median space, to allow the flame-cutting burner or the trimmer to pass following the side of the tong hold they are on.

As various changes could be made in the above constructions without departing from the scope of the invention, it is intended that all matter contained in the above description or shown in the accompanying drawings shall be interpreted as illustrative and not in a limiting sense.

1. A flame-cutting process for a parallelepiped slab using one or more flame-cutting blowtorches, the slab having a primary plane; the process comprising using a lifting device to lift a slab from a flat position to bring its primary plane into a vertical position; holding the slab in the vertical position using said lifting device; and causing relative vertical movement between said one or more flame-cutting blowtorches and said slab to cut the slab as it passes before the activated flame-cutting blowtorch.

2. The flame-cutting process according to claim 1, wherein said lifting device comprises of one or more electromagnets; the step of lifting the slab including placing the one or more electromagnets in contact with the side of the slab away from and opposite to the flame-cutting blowtorch and moving the electromagnet both vertically and transversely perpendicular to the plane of said vertical position to bring the primary plane of slab into said vertical position.

3. The flame-cutting process according to claim 2 wherein the step of causing relative vertical movement between said one or more flame-cutting blowtorches and said slab includes a step of lowering the electromagnet vertically after the blowtorch is activated until the lower edge of slab is in a slab-holding device, and then moving said blowtorch vertically upwards along slab to cut the slab.

4. The flame-cutting process according to claim 3, wherein the slab is placed vertically on its edge.

5. The flame-cutting process according to claim 3, wherein the slab is placed standing vertically.

6. The flame-cutting process according to claim 1, wherein, during said lifting step, said lifting device acts from the bottom of the slab that is lying flat, to tip the slab around its edge near the blowtorch with its primary plane against a vertical plane and acts to hold the slab in place in this vertical position.

7. The flame-cutting process according to claim 6, wherein said step of causing relative movement between said blow torch and said slab comprises moving said blowtorch vertically downwards or upwards along slab over a distance longer than the slab.

8. The flame-cutting process according to claim 6, wherein the slab is mounted standing.

9. The flame-cutting process according to claim 6, wherein said slab is placed on its side.

10. A device for implementation of the flame-cutting process, comprising at least one flame-cutting blowtorch; a lifting device to lift a slab and place the slab before said blowtorch with the primary plane of the slab in a vertical position and to hold the slab in this position during cutting of the slab; and a means for moving said blowtorch vertically upwards or downwards along the primary plane of the slab in the vertical position.

11. The device according to claim 10 wherein the lifting device is an electromagnet moveable vertically and transversally relative to said primary vertical plane of the slab.

12. The device according to claim 11 including a holding device designed to receive the lower edge of slab when the edge is in the vertical position, standing or on its side.

13. The device according to claim 10 wherein said lifting device comprises a slab-support table moveable between a horizontal rest position and a working position perpendicular to the rest position and at least one straight slab-support post vertical to said rest position; the slab being lifted to a position in which its primary plane is in a vertical position and the slab is positioned between the slab-support table in its work position and the slab-support post.

14. The device according to claim 13, including at least one hydraulic actuator connected at one end to said slab-support table and which is operable to move said slab-support table from in its horizontal position about the opposite end of said table to its vertical work position.
